(19) United States
(12) Patent Application Publication
(10) Pub. No.: US 2004/0064354 A1
(43) Pub. Date: Apr. 1, 2004

(54) Method and system of assembling a tem from a collection of resumes

(75) Inventors: Brenda Lynn Dietrich, Yorktown Heights, NY (US); Edith Helen Stern, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/254,865

(22) Filed: Sep. 26, 2002

(51) Int. Cl. G06F 17/60

(52) U.S. Cl. 705/9

(57) ABSTRACT

A method (and a system) for selecting team members includes retrieving requirements for at least one task, retrieving data regarding skills of a potential team member, and determining whether the requirements are at least partially satisfied by the skills of the potential team member.

### BACKGROUND OF THE INVENTION

1. Field of the Invention

The present invention generally relates to assembling a team from a collection of resumes, and more particularly to a method and system of assembling a team from a collection of resumes using a task database and a resource database and selecting resources from the resource database to satisfy conditions in the task database.

2. Description of the Related Art

In today's information technology (IT) dependent world, there are hundreds of thousands of IT jobs that are unfilled in the US alone. At the same time, there are thousands of resumes available electronically. Oftentimes, a particular resume does not suit a particular job because the background of the individual, when considered alone, does not supply the needed mix of skills and experience required. Needless to say, while there is a serious shortfall in IT skills, there are many other skills which teams must have to mount a successful project, or a successful adhoc business.

Increasingly in skill-or-knowledge based industries, such as professional services and information technology, tasks require complex combinations of highly specialized skills. Although some tasks are still executed by a single highly skilled individual, many tasks are executed by a team of individuals. With the increased use of computer and communications networks, the trends toward increased specialization, the use of contract labor and business process out-sourcing, the pool of resources from which to construct a team has grown significantly.

Assembling a team has become a significant business challenge. The team requirements must be specified. The skills and availability of each potential team member must be specified. The team is then assembled so that all of the needed skills are included. In general, there may be many distinct teams that have the skills necessary to complete a task. There is also usually a cost associated with assembling a team for a task. This cost may include travel cost, training costs, “risks” associated with the experience of the team members, and opportunity costs associated with other tasks which team members could contribute. There may also be other limits on the composition of teams. For example, certain individuals may be unwilling or unable to work with one another, individuals may be unable to travel to certain locations, or may be unavailable for certain periods of time.

Assembling a single team so as to include all of the required skills and conform to any limits on team composition is a difficult problem. Assembling a team at minimum cost is more difficult. The actual problem faced by many businesses involves assembling multiple teams, for multiple tasks, each with specified skill requirements and start and completion dates.

This problem is traditionally solved by manual methods. The various skills required for a team are considered individually, in some order. Available resources are allocated to fill the skill requirement under consideration. The availability of the allocated resources are decreased to reflect the allocation. However, this does not lead to a team optimization, particularly in the case where resources possess multiple skills. It also does not lead to cost savings or risk reduction. It does not effectively deal with team composition considerations. It is also not effective in allocating resources to multiple teams. In the event of constrained resources, it provides no insight into the selection of tasks to be completed. It does not provide insight into the utility of additional skills or resources.

Further, such methods can be time consuming to apply and allow little capability to apply additional constraints related to skills redundancy, cost, or specific task constraints.

### SUMMARY OF THE INVENTION

In view of the foregoing and other problems, drawbacks, and disadvantages of the conventional methods and structures, an object of the present invention is to provide a method and structure in which mathematical models and solutions exactly or approximately solve the models to determine allocations of multiple resources to at least one team.

In a first aspect of the present invention, a method (and system) for selecting team members includes receiving data regarding requirements for at least one task, receiving data regarding skills of a potential team member, and determining whether the requirements are at least partially satisfied by the skills of the potential team member.

In a second aspect of the present invention, a computer readable medium stores instructions for selecting team members, which when executed by one or more processors, causes the processors to perform receiving data regarding requirements for at least one task receiving data regarding skills of a potential team member, and determining whether the requirements are at least partially satisfied by the skills of the potential team member.

In a third aspect of the present invention, a team member selection apparatus includes a device for receiving data regarding requirements for at least one task, a device for receiving data regarding skills of a potential team member, and a device for determining whether the requirements are at least partially satisfied by the skills of the potential team member.

The present invention uses optimization algorithms to select a project team where the collective skills and experience of the team is optimized, rather than each individual, to fulfill the requirements of the project. Further, the present invention allows constraints related to cost as well as team size, composition and skill redundancy to be considered in the selection of teams.

With the invention, a method is provided for assembling a team from a collection of potential team members. The capabilities of each potential team member are known, for example, via a skills database or individual resumes. The inventive method for assembling a team also may consider cost or availability factors, also may assemble or modify a collection of teams. Further, the invention provides a method for using byproducts of the assembly process to determine a list of skills for which availability should be increased.

The present invention can also be used to assemble minimum sized teams. It can also be used to minimize the number of tasks to which a resource is assigned. Further, the invention recognizes that it is often not possible to complete all desirable tasks, and, thus, this invention may be used to select which tasks to complete in order to maximize value of completed work.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 is a schematic representation of one exemplary embodiment of an apparatus 100 in accordance with the invention;

FIG. 2 is a schematic representation of one exemplary embodiment of a computer readable medium 200 storing instructions for selecting team members in accordance with the invention;

FIG. 3 is a schematic representation of an exemplary control routine 300 in accordance with the present invention; and

FIG. 4 is a representation of a task database entry 400 for one task T in accordance with the present invention.

### DETAILED DESCRIPTION OF EXEMPLARY EMBODIMENTS OF THE INVENTION

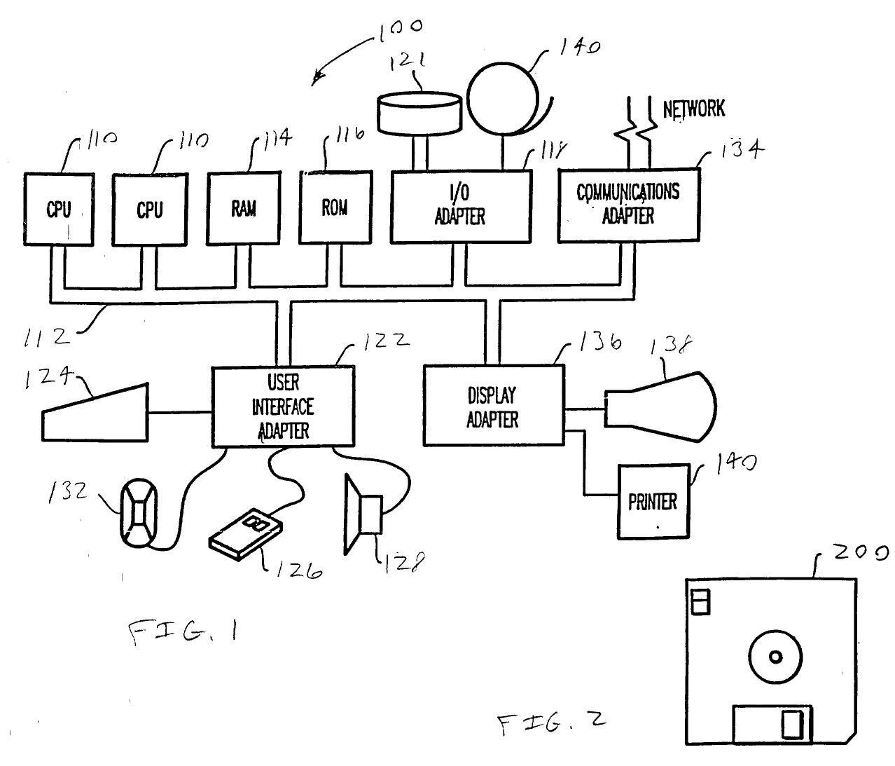

Referring now to the drawings, and more particularly to FIGS. 1-4, there are shown exemplary embodiments of the method and structures according to the present invention.

FIG. 1 illustrates a typical hardware configuration of an information handling/computer system for use with the invention and which preferably has at least one processor or central processing unit (CPU) 110.

The CPUs 110 are interconnected via a system bus 112 to a random access memory (RAM) 114, read-only memory (ROM) 116, input/output (I/O) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or printer 140.

In addition to the hardware/software environment described above, a different aspect of the invention includes a computer-implemented method for performing the above described methods. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

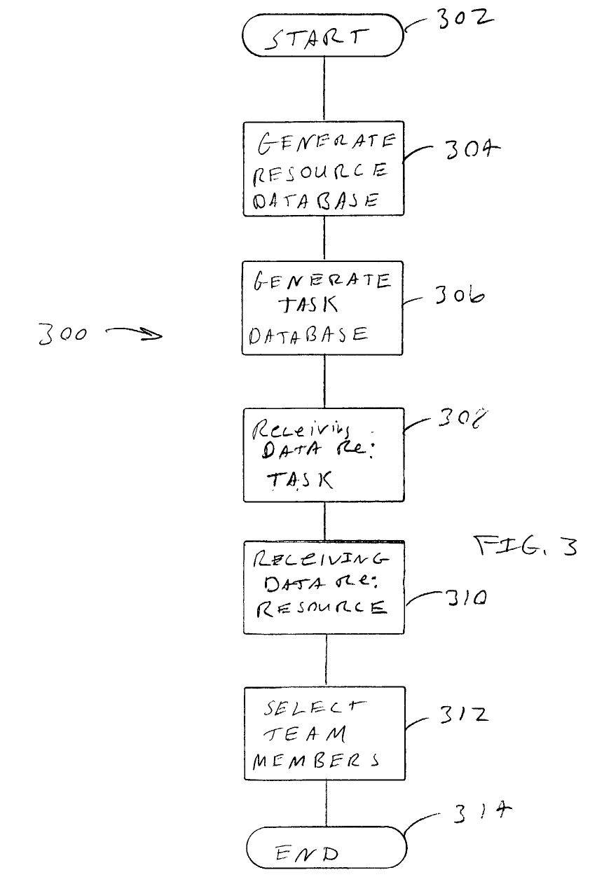

This signal-bearing media may include, for example, a RAM contained within the CPU 110, as represented by the fast-access storage for example. Alternatively, the instructions may be contained in another signal-bearing media, such as a magnetic data storage diskette 200 (FIG. 2), directly or indirectly accessible by the CPU 110.

Whether contained in the diskette 200, the computer/CPU 110, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

In a first exemplary embodiment of the invention, assembling a team for a single task involves:

(1) Receiving data describing the task which is preferably given as a list of required skills, and a quantity (e.g., hours or person months) for each skill;

(2) Receiving data describing each potential team member (also called a “resource”) which is typically given as total availability, along with a list of skills, and may optionally include information regarding cost and efficiency for each skill; and

(3) Selecting from among the potential team members a set of team members, such that the team includes the required skills at the required quantities.

FIG. 3 shows a schematic representation of an exemplary control routine 300 in accordance with the present invention.

The control routine 300 starts at step 302 and continues to step 304 where a resource database is generated. The control routine then continues to step 306 where a task database is generated. The control routine then continues to step 308 where the control routine receives data regarding tasks. This data may be received from one or more sources. It may be received from a task database, it may be received via user entry or be read from removable media, or the data may be received via a network.

The control routine next continues to step 310. In step 310, the control routine receives data regarding a resource. This data may be received from a resource database, it may be received via user entry or be read from removable media, or it may be received via a network.

The control routine next continues to step 312. In step 312, the control routine selects a team member from among the resources represented by the data received in step 310. The resource is selected for assignment to a team if the resource matches the requirements of at least one of the tasks for which data was received in step 308. The control routine continues to step 314. In step 314, the control routine ends operation.

It is to be understood that the various steps of the flowchart of FIG. 3, may be rearranged as long as step 312 is provided with sufficient information to make a determination as to whether a resource is assigned to a given task.

This selection step is equivalent to determining a feasible solution to a mathematical optimization problem, and can be solved using heuristic methods or commercial mathematical optimization software. In the simplest case, described here for illustrative purposes, each resource has only one skill. In yet a more realistic case, each resource has multiple skills, but can use only one of these skills on a task. In yet a more complex case, each resource has multiple skills, and can use multiple skills on a task. An exemplary embodiment of this invention uses decision variables to represent the percentage of a resource's time that is spent providing each possible skill, and preferably at most 100% of the resource's available time is used to complete the task.

If the task is of a long duration or the various skills required to complete the task are required during different intervals, then the implementation above can be augmented to include explicit representation of time. In this case assembling a team for the single task involves:

(1) Receiving data describing the task which is preferably given as a list of triples (interval, skill, quantity required);

(2) Receiving data describing team members preferably specified as a sequence of pairs for each resource (e.g., interval, availability), along with a list of skills and information regarding the cost and efficiency of the resource for each of the skills; and

(3) Selecting from among the potential team members a set of team members such that the team includes the required skills in the required quantities during each interval.

In an exemplary embodiment of the invention, this selection step is equivalent to determining a feasible solution to a mathematical optimization problem, and can be solved using heuristic methods or commercial mathematical optimization software.

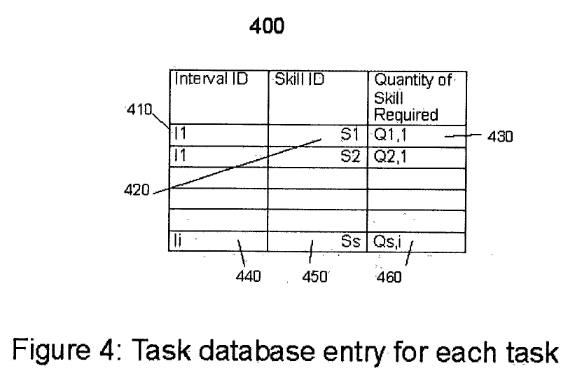

FIG. 4 shows a representation of a database entry 400 for a single task T. Entry 410 and entry 440 indicate which interval is being specified. Entry 410 refers to the first interval, and entry 440 refers to the ith interval (i.e., the last one required for this task). Entries 420 and 450 indicate a skill which is required. Entry 420 indicates that skill S1 is required in the first interval. Entry 450 indicates that skill Ss is required in the ith interval. Entries 430 and 460 indicate the quantity of the skills required in the given interval. Entry 430 indicates that Q1,1 of skill S1 is required in I1. Entry 460 indicates that Qs,i of skill Ss is required in the Ii interval. Each skill required for task T is represented for each interval of duration of task T in which the skill is required.

One skilled in the art will observe that the formulas described below can be modified to reflect many considerations on team composition. As an example, if two resources are unwilling or unable to work together, this consideration can be reflected in the formulas through the inclusion of an additional constraint.

In many instances, it is desirable to assemble a team that limits or minimizes cost. In this case, the cost of assigning each resource to the team must be specified in the input data. The inventors assume that this cost function includes a fixed cost component as well as a variable cost component. The entire fixed cost is incurred if the resource is assigned to the team, regardless of the amount of time spent by the resource or the skills used by the resource. Fixed cost can be used to reflect travel costs, hiring costs, contracting costs, training costs, and other one-time costs associated with assigning a resource to a team. The variable cost is interpreted as a cost per unit time spent on the team; different costs may be applied depending on the skill being provided by the resource. This cost data is used to modify an exemplary embodiment of the invention. Total team cost can either be considered as an additional model constraint, or can be used as an objective function in the formulation.

Additional cost factors that can be included by giving preference to smaller teams, or to teams in which each skill is possessed by at least two members.

An exemplary embodiment of the invention can also be augmented to reflect risk of assigning certain resources to a team. Like cost, total acceptable risk can be included as a constraint, or incorporated in the objective function.

In another exemplary embodiment, a similar approach can be used to assign resources to multiple teams, with each team charged with completing one task. First consider the case where all tasks must be completed. Several cases are possible, including each resource being assigned to at most one team, resources being shared across all teams, and resource sharing prohibited across some combinations of teams.

If each resource is assigned to at most one team, then assembling multiple teams for multiple tasks involves:

(1) Receiving data describing each task where the data for each task is preferably given as a list of required skills, and a quantity (e.g., hours or person months) for each skill;

(2) Receiving data describing each potential team member (also called a “resource”) which is typically given as total availability, along with a list of skills, and may optionally include information regarding cost and efficiency for each skill; and

(3) Selecting from among the potential team members a set of team members for each task such that the team assigned to a task includes the required skills at the required quantities, and such that each potential team member is assigned to at most one task.

This selection step is equivalent to determining a feasible solution to a mathematical optimization problem, and can be solved using heuristic methods or commercial mathematical optimization software.

The option of assigning a resource to multiple teams typically corresponds to the case where tasks have skill requirements specified according to some schedule. In this case assembling multiple teams for the multiple tasks involves:

(1) Receiving data describing the tasks which, for each task, is preferably given as a list of triples (e.g., interval, skill, quantity required);

(2) Receiving data describing team members preferably specified as a sequence of pairs for each resource (e.g., interval, availability), along with a list of skills and information regarding the cost and efficiency of the resource for each of the skills; and

(3) Selecting from among the potential team members a set of teams, such that the members of the i-th team includes the skills required by the i-th task in the required quantities during each interval and such that each potential team member is assigned to at most one task in any interval.

One skilled in the art will observe that additional considerations, such as a resource being assigned to a small number of total tasks, or being swapped on and off of the same task, can also be represented as constraints. As in the single task case, cost and risk can be computed for each task, and can modeled either as constraints or as components of an objective function. The cost of each task can be constrained to be less than a specified value, or the total cost of one or more sets of tasks (such as a task being done for the same customer) can be constrained to be less than a value specified for that set, or the total costs of all tasks can be constrained to be less than some value. If cost is used as an objective, weights can be assigned to each task, or to one or more sets of tasks. Similar variations can be applied to the handling of risk.

There may be instances which include the possibility of not doing some task. In this case, in an exemplary embodiment of the invention, additional decision variables are used to represent whether or not a task is to be done. In this case, the selection of which tasks to complete may be guided by priorities specifying the relative importance of tasks, or by economic factors, such as cost or profit. These factors are typically specified in an objective function.

When selecting tasks, precedence considerations may be required, if one task is dependent on the prior completion of another task. Precedence considerations can be represented by constraints on the task selection variables.

Additional consideration may further restrict the acceptable combinations of tasks. In general, mathematical programming formulations allow the representation of many forms of such considerations. As long as the consideration can be represented as a linear constraint on the decision variables, commercial mathematical optimization software can be used to determine which tasks to select. In addition, many instances of nonlinear relationships can be addressed through iterated use of commercial mathematical programming software.

The allocation methods of an exemplary embodiment of the invention can also be used to determine the need for or desirability of additional resources. Examining the remaining resources, those that are not assigned to teams, gives some indication of surpluses. To determine the desirability of adding an additional resource with a particular skill, one can modify the allocation formulation to include an additional, hypothetical, resource with the skill, and compute the solution to this augmented allocation formulation. If risk is decreased, cost is decreased, profit is increased, or if a previously unfeasible problem becomes feasible, then the value of the additional resource can be approximated as the value of the assignment of the augmented formulation minus the value of the assignment of the unaugmented formulation. In certain instances, standard outputs of the mathematical optimization procedure, known as dual variables, can also be used to infer the value of increasing the availability of a skill.

One Task—One Team

The following is a basic one-task, one-team formulation for a first exemplary embodiment:

S=set of skills, indexed by s.

R=set of resources, indexed by r.

αᵣ=availability of resource resource r

Sᵣ=set of skills possessed by resource r.

e_{r,s}(ε[0, 1])=efficiency of resource r on skill sεSᵣ. This data is optional, and if not available the value 1 is used. For convenience, assume e_{r,s}=0 for all sεSᵣ.

p_{r,s}(≧0)=per unit risk of resource r on skill s. This data is optional, and if not available the value 0 is used.

fᵣ=fixed cost of participation by resource r. This data is optional, and if not available the value 0 is used.

c_{r,s}(>0)=unit cost of resource r applying skill s. This data is optional, and if not available the value 0 is used.

qₛ=requirement for skill s.

C=total task budget.

P=total allowed risk.

In the simplest case, described here for illustrative purposes, each resource has only one skill. That is, for each resource r, the set Sᵣ contains only one element.

This formulation requires one decision variable per resource; the decision variable indicates whether the resource is allocated to the team. Let xᵣ=1 if resource r is allocated to the team, and let xᵣ=0 otherwise. The effective contribution of resource r toward the completion of the task is aᵣe_{r,s}xᵣ units (hours, weeks) toward the requirement of qs units of skill s.

To complete the task, for each skill sεS, the sum

$${\sum }_{r ∈ R}^{}$$

αᵣe_{r,s}xᵣ must be at least as large as the requirement qₛ. Thus, any team that can complete the task corresponds to a set of 0-1 values for the decision variables Xr that simultaneously satisfies the set of linear inequalities:

$${\sum }_{r ∈ R}^{} {a}_{r} {e}_{r , s} {x}_{r} \geq {q}_{s} . for all s ∈ S \qquad ( 1 )$$

Such values can be found through the use of mathematical optimization software, such as IBM's product OSL®, or through the use of various heuristics and search methods.

In a more realistic case, each resource has multiple skills, but can use only one of these skills on a task. In this case, the decision variable is indexed by both the skill and the resource. Let u_{r,s}=1 if resource r uses skill s on the task, and let u_{r,s}=0 otherwise. The effective contribution of a resource r toward the completion of the task is aᵣe_{r,s}u_{r,s} units. The limitation that resource r can only apply one skill to the task is represented by requiring that the sum over the skills in Sᵣ of the variables u_{r,s} not exceed 1. Thus, any team that can complete the task corresponds to a set of 0-1 values for the decision variables u_{r,s} that simultaneously satisfies the set of linear inequalities:

$$\begin{matrix}{\sum }_{r ∈ R}^{} {a}_{r} {e}_{r , s} {u}_{r , s} \geq {q}_{s} . for all s ∈ S & ( 2 ) \\ {\sum }_{s ∈ {S}_{r}}^{} {u}_{r , s} \leq 1 for all r ∈ R & ( 3 )\end{matrix}$$

Such values can be found through the use of mathematical optimization software, such as IBM's product OSL®, or through the use of various heuristics and search methods.

In an even more complex case, each resource has multiple skills, and can use multiple skills on a task. In this case, we use a 0-1 decision variable to indicate selection of a resource, and a continuous decision variable to indicate the percentage of time each resource uses each available skill. Preferably, at most 100% of the resource's available time is used to complete the task. Let xᵣ=1 if resource r is allocated to the team, and let xᵣ=0 otherwise. Let u_{r,s}ε[0,1] be the portion of time resource r uses skill s on the task. The effective contribution of resource r toward the completion of the task is aᵣe_{r,s}u_{r,s} units. Preferably, u_{r,s}=0 whenever xᵣ=0. That is, if the resource is not on the project, then they do not contribute any time for any skill. Thus, any team that can complete the task corresponds to a set of 0-1 values for the decision variables xᵣ and a set of values in the interval [0,1] for the decision variables u_{r,s} that simultaneously satisfies the set of linear inequalities:

$$\begin{matrix}{\sum }_{r ∈ R}^{} {a}_{r} {e}_{r , s} {u}_{r , s} \geq {q}_{s} . for all s ∈ S & ( 4 ) \\ {\sum }_{s ∈ {S}_{r}}^{} {u}_{r , s} \leq {x}_{r } for all r ∈ S & ( 5 )\end{matrix}$$

Such values can be found through the use of mathematical optimization software, such as IBM's product OSL®, or through the use of various heuristics and search methods.

For any of these formulations, it is likely that there will be many distinct sets of values for the objective functions that satisfy the constraints. Each such set of values is called a “feasible solution.” It may be beneficial to select a feasible solution satisfying some other criteria, such as minimizing or limiting cost, or minimizing or limiting risk. These criteria can be expressed in terms of the input data and the decision variables.

For example, the total cost of an allocation is given by:

$${\sum }_{r ∈ R}^{} {f}_{r} {x}_{r} + {\sum }_{r ∈ R}^{} {\sum }_{s ∈ {S}_{r}}^{} {c}_{r , s} {a}_{r} {u}_{r , s} . \qquad ( 6 )$$

The total risk of an allocation is given by:

$${\sum }_{r ∈ R}^{} {\sum }_{s ∈ {S}_{r}}^{} {p}_{r , s} {a}_{r} {u}_{r , s} . \qquad ( 7 )$$

A budget constraint takes the form:

$${\sum }_{r ∈ R}^{} {f}_{r} {x}_{r} + {\sum }_{r ∈ R}^{} {\sum }_{s ∈ {S}_{r}}^{} {c}_{r , s} {a}_{r} {u}_{r , s} \leq C \qquad ( 8 )$$

A risk constraint takes the form:

$${\sum }_{r ∈ R}^{} {\sum }_{s ∈ {S}_{r}}^{} {p}_{r , s} {a}_{r} {u}_{r , s} \leq P . \qquad ( 9 )$$

Other possible constraints include limiting the total number of team members and requiring skill redundancy. The total number of team members is given by:

$${\sum }_{r ∈ R}^{} {x}_{r} \qquad ( 10 )$$

and this value can be limited by adding a constraint of the form:

$$TLB \leq {\sum }_{r ∈ R}^{} {x}_{r} \leq TUB \qquad ( 11 )$$

where TLB and TUB are lower and upper bounds on the team size, respectively.

Skill redundancy can be enforced by requiring that the number of team members possessing a given skill exceeds some lower bound, or that the total availability of team members possessing some skill (regardless of the percentage actually allocated to that skill) exceeds some lower bound. Formulation is analogous to the team size constraint, except that the sum is restricted to resources possessing the specific skill under consideration. That is,

$$SLB \leq {\sum }_{r ∈ R \text{:} s ∈ {S}_{r}}^{} {x}_{r} \qquad ( 12 )$$

where SLB is the lower bound on the number of team members possessing the skill, and

$$QLB \leq {\sum }_{r ∈ R \text{:} s ∈ {S}_{r}}^{} {a}_{r} {x}_{r} \qquad ( 13 )$$

where QLB is the lower bound on the total availability of team members possessing the skill.

Other team composition constraints, not related to skills are also possible. Let R′ be an arbitrary subset of R, and let LB_{R′} and UB_{R′} be non-negative values between 0 and the carnality of R′. Then, in another exemplary embodiment of the invention, one can restrict to allocations that include at least LB_{R′} but not more than UB_{R′} members of R′ by adding a constraint of the form:

$${LB}_{{R}^{′}} \leq {\sum }_{r ∈ {R}^{′}} {x}_{r} \leq {UB}_{{R}^{′}} . \qquad ( 14 )$$

A general formulation, which seeks to minimize a weighted combination of cost and risk, subject to a total team size constraint and a skills redundancy constraint is given below. w_{cst} is the weighting factor for cost and wᵣᵢₛₖ is the weighting factor for risk.

$$MIN {w}_{cst} ( {\sum }_{r ∈ R} {f}_{r} {x}_{r} + {\sum }_{r ∈ R} {\sum }_{s ∈ {S}_{r}} {c}_{r , s} {a}_{r} {u}_{r , s} ) + {w}_{risk} {\sum }_{r ∈ R} {\sum }_{s ∈ {S}_{r}} {p}_{r , s} {a}_{r} {u}_{r , s} \qquad ( 15 )$$

Subject to:

$$\begin{matrix}{\sum }_{r ∈ R} {a}_{r} {e}_{r , s} {u}_{r , s} \geq {q}_{s} . for all s ∈ S & ( 16 ) \\ {\sum }_{s ∈ {S}_{r}} {u}_{r , s} \leq {x}_{r} for all r ∈ R & ( 17 ) \\ {\sum }_{r ∈ R} {f}_{r} {x}_{r} + {\sum }_{r ∈ R} {\sum }_{s ∈ {S}_{r}} {c}_{r , s} {a}_{r} {u}_{r , s} \leq C & ( 18 ) \\ {\sum }_{r ∈ R} {\sum }_{s ∈ {S}_{r}} {p}_{r , s} {a}_{r} {u}_{r , s} \leq P . & ( 19 ) \\ TLB \leq {\sum }_{r ∈ R} {x}_{r} \leq TUB , & ( 20 ) \\ {SLB}_{s} \leq {\sum }_{r ∈ R \text{:} s ∈ {S}_{r}} {x}_{r} , for all s ∈ S & ( 21 ) \\ {QLB}_{s} \leq {\sum }_{r ∈ R \cdot s ∈ {S}_{r}}^{} {a}_{r} {x}_{r} , for all s ∈ S & ( 22 ) \\ {LB}_{{R}^{′}} \leq {\sum }_{r ∈ {R}^{′}} {x}_{r} \leq {UB}_{{R}^{′}} for all {R}^{′} ⊆ R & ( 23 )\end{matrix}$$

xᵣε{0,1} for all rεR (24)

u_{r,s}≧0 for all sεS,rεR (25)

If the task is of a long duration or the various skills required to complete the task are required during different intervals, then the implementation above can be augmented to include an explicit representation of time. In this case additional data, reflecting the time-phased requirements and availability of resources are added. For this embodiment, assume that the time horizon has been divided into a set I of intervals indexed by i. The input data is permitted to be time dependent. That is, values are specified for each of the intervals. Note that some of the values, such as skill, cost, and efficiency may in fact, be independent of time. However, for convenience and full generality, this exemplary embodiment permits the possibility of time dependence, and uses an additional subscript, i to indicate the interval associated with each data element. Much of the notation from the earlier model is repeated here.

Notation:

S=set of skills, indexed by s.

R=set of resources, indexed by r.

I set of intervals indexed by i.

a_{r,i}=availability of resource resource r in interval i.

S_{r,i}=set of skills possessed by resource r in interval i. (Note: the time dependency here may be a result of training)

e_{r,s,i}(ε[0,1])=efficiency of resource r on skill sεSᵣ in interval i.

This data is optional, and if not available the value 1 is used. For convenience, the inventors assume e_{r,s,i}=0 for all s∉S_{r,i}.

p_{r,s,i}(≧0)=risk per unit of use of resource r on skill s in interval i. This data is optional, and if not available the value 0 is used.

fᵣ=fixed cost of participation at any time by resource r. This data is optional, and if not available the value 0 is used.

f_{r,i}=fixed cost of participation during interval i by resource r. This data is optional, and if not available the value 0 is used.

c_{r,s,i}(≧0)=unit cost of resource r applying skill s in interval i. This data is optional, and if not available the value 0 is used.

q_{s,i}=requirement for skill s in interval i.

C=total task budget.

P=total allowed risk.

This exemplary embodiment addresses a complex case, in which each resource has multiple skills, and can use multiple skills on the task. More restrictive cases can be derived from this exemplary embodiment by one skilled in the art. In this case, a 0-1 decision variable to indicate selection of a resource, additional 0-1 variables to indicate usage of a resource on the team during the different intervals, and continuous decision variables to indicate the percentage of time each resource uses each available skill in each interval may be used. Preferably, at most 100% of the resource's available time is used in each interval. Let xᵣ=1 if resource r is allocated to the team, and let xᵣ=0 otherwise. Let x_{r,i}=1 if resource r is allocated to the team in interval i, and let x_{r,i}=0 otherwise. Note that x_{r,i}=0 whenever xᵣ=0. Let u_{r,s,i}ε[0, 1] be the portion of time resource r uses skill s on the task in interval i. The effective contribution of resource r toward the completion of the task in interval i, is a_{r,i}e_{r,s,i}u_{r,s,t} units. Preferably, u_{r,s,i}=0 whenever x_{r,i}=0. Thus, any team that can complete the task corresponds to a set of 0-1 values for the decision variables xᵣ and x_{r,i} and a set of values in the interval [0, 1] for the decision variables u_{r,s,i} that simultaneously satisfies the set of linear inequalities:

$$\begin{matrix}{\sum }_{r ∈ R} {a}_{r , i} {e}_{r , s , i} {u}_{r , s , i} \geq {q}_{s , i} . for all s ∈ S , i ∈ I & ( 26 ) \\ {\sum }_{s ∈ {S}_{r , i}} {u}_{r , s , i} \leq {x}_{r , i} for all r ∈ R i ∈ I & ( 27 )\end{matrix}$$

x_{r,i}≦xᵣ for all rεR iεI. (28)

Such values can be found through the use of mathematical optimization software, such as IBM's product OSL, or through the use of various heuristics and search methods. Note that if f_{r,i}=0, and other side constraints involving period by period team composition are not required, then the variables x_{r,i} are not required—as they can be replaced by the variable xᵣ wherever they appear.

The full formulation is given by:

$$MIN {w}_{cst} ( {\sum }_{r ∈ R} {f}_{r} {x}_{r} + {\sum }_{r ∈ R} {\sum }_{i ∈ I} {f}_{r , i} {x}_{r , i} + {\sum }_{r ∈ R} {\sum }_{s ∈ {S}_{r}} {\sum }_{i ∈ I} {c}_{r , s , i} {a}_{r , i} {u}_{r , s , i} ) + {w}_{risk} {\sum }_{r ∈ R} {\sum }_{s ∈ {S}_{r}} {\sum }_{i ∈ I} {p}_{r , s , i} {a}_{r , i} {u}_{r , s , i} \qquad ( 29 )$$

Subject to:

$$\begin{matrix}{\sum }_{r ∈ R} {a}_{r , i} {e}_{r , s , i} {u}_{r , s , i} \geq {q}_{s , i} . for all s ∈ S , i ∈ I & ( 30 ) \\ {\sum }_{s ∈ {S}_{r}} {u}_{r , s , i} \leq {x}_{r , i} for all r ∈ R , i ∈ I & ( 31 )\end{matrix}$$

x_{r,i}≦xᵣ for all rεR,iεI (32)

$$\begin{matrix}{\sum }_{r ∈ R} {f}_{r} {x}_{r} + {\sum }_{r ∈ R} {\sum }_{i ∈ I} {f}_{r , i} {x}_{r , i} + {\sum }_{r ∈ R} {\sum }_{s ∈ {S}_{r}} {\sum }_{i ∈ I} {c}_{r , s , i} {a}_{r , i} {u}_{r , s , i} \leq C & ( 33 ) \\ {\sum }_{r ∈ R} {\sum }_{s ∈ {S}_{r}} {p}_{r , s , i} {a}_{r , i} {u}_{r , s , i} \leq P & ( 34 ) \\ TLB \leq {\sum }_{r ∈ R} {x}_{r} \leq TUB , & ( 35 ) \\ {SLB}_{s} \leq {\sum }_{r ∈ R \text{:} s ∈ {S}_{r}} {x}_{r} , for all s ∈ S & ( 36 ) \\ {QLB}_{s} \leq {\sum }_{r ∈ R \cdot s ∈ {S}_{r}}^{} {a}_{r , i} {x}_{r , i} , for all s ∈ S , i ∈ I & ( 37 ) \\ {LB}_{{R}^{′}} \leq {\sum }_{r ∈ {R}^{′}} {x}_{r} \leq {UB}_{{R}^{′}} for all {R}^{′} ⊆ R & ( 38 )\end{matrix}$$

xᵣε{0,1} for all rεR (39)

x_{r,i}ε{0,1} for all rεR,iεI (40)

u_{r,s,i}≧0 for all sεS,rεR,iεI (41)

Additional modifications to reflect constraints that apply only to specific cases are possible and can be implemented by one skilled in the art.

Multi-Task Multi-Team

The following is a formulation for a second exemplary embodiment accomodating multiple tasks and multiple teams.

A similar mathematical programming approach in accordance with the present invention can be used to assign resources to multiple teams, with each team charged with completing one task. First, consider the case where all tasks must be completed. Several cases are possible, including each resource being assigned to at most one team, resources being shared across all teams, and resource sharing prohibited across some combinations of teams. We limit the formulation to the case of long duration tasks, and note that the single interval formulation can be derived by simply suppressing the interval subscript.

Much of the notation from the earlier model is repeated here.

Notation:

S=set of skills, indexed by s.

R=set of resources, indexed by r.

I=set of intervals, indexed by i.

T=set of tasks, indexed by t.

a_{r,i}=availability of resource resource r in interval i.

S_{r,i}=set of skills possessed by resource r in interval i. (Note: the time dependency here may be a result of training)

e_{r,s,i}(ε[0, 1])=efficiency of resource r on skill sεSᵣ in interval i.

This data is optional, and if not available the value 1 is used. For convenience, the inventors assume e_{r,s,i}=0 for all s∉S_{r,i}.

p_{t,r,s,i}(≧0)=risk of resource r on task t using skill s in interval i. This data is optional, and if not available the value 0 is used.

f_{t,r}=fixed cost of participation on task t at any time by resource r. This data is optional, and if not available the value 0 is used.

f_{t,r,i}=fixed cost of participation on task t during interval i by resource r. This data is optional, and if not available the value 0 is used.

c_{t,r,s,i}(≧0)=unit cost of resource r applying skill s in interval i on task t. This data is optional, and if not available the value 0 is used.

q_{t,s,i}=requirement for skill s on task t in interval i.

C=total task budget.

Cₜ=total task budget for task t.

P=total allowed risk.

Pₜ=total allowed risk for task t.

The following exemplary embodiment addresses the complex case, in which each resource has multiple skills, and can use multiple skills on the tasks to which it is assigned. The more restrictive cases can be derived from this case by one skilled in the art. In this case, a 0-1 decision variable to indicate selection of a resource for tasks, additional 0-1 variables to indicate usage of a resource for a task during the different intervals, and continuous decision variables to indicate the percentage of time each resource uses each available skill on each task in each interval may be used. Preferably, at most 100% of the resource's available time is used in each interval.

Let x_{t,r}=1 if resource r is allocated to the team performing task t, and let x_{t,r}=0 otherwise. Let x_{t,r,i}=1 if resource r is allocated to the team performing task t in interval i, and let x_{t,r,i}=0 otherwise. Note that x_{t,r,i}=0 whenever x_{t,r}=0. Let u_{t,r,s,i}ε[0, 1] be the portion of time resource r uses skill s on task t in interval i. The effective contribution of resource r toward the completion of task t in interval i, is a_{r,i}e_{r,s,i}u_{t,r,s,i} units. u_{t,r,s,i}=0 whenever x_{t,r,i}=0. Thus, any assignment of resources to teams that can complete the set of tasks corresponds to a set of 0-1 values for the decision variables x_{t,r} and x_{t,r,i} and a set of values in the interval [0, 1] for the decision variables u_{t,r,s,i} that simultaneously satisfies the following set of linear inequalities:

$$\begin{matrix}{\sum }_{r ∈ R} {a}_{r , i} {e}_{r , s , i} {u}_{t , r , s , i} \geq {q}_{t , s , i} . for all s ∈ S , i ∈ I , t ∈ T & ( 42 ) \\ {\sum }_{t ∈ T} {\sum }_{s ∈ {S}_{r , i}} {u}_{t , r , s , i} \leq 1 for all r ∈ R i ∈ I & ( 43 ) \\ {\sum }_{s ∈ {S}_{r , i}} {u}_{t , r , s , i} \leq {x}_{t , r , i} for all r ∈ R i ∈ I , t ∈ T & ( 44 )\end{matrix}$$

The first set of constraints (42) reflects the requirement that all of the tasks be assigned adequate resources. The second set of constraints (43) reflects the requirement that each resource cannot be utilized more than 100% of the time. The third set of constraints (44), and the 0-1 variable are used to keep track of costs and to allow for formulation of other team composition restrictions.

Such values can be found through the use of mathematical optimization software, such as IBM's product OSL®, or through the use of various heuristics and search methods.

All of the considerations on team composition included in the single team model can be extended to the multiple team model. The objective function (45) is a weighted combination of cost and risk. The first set of constraints (46) ensures that sufficient quantity of resource is applied to each task in each interval. The second set (47) ensures that at most 100% of a resources available time is allocated. The third (48) and fourth (49) set of constraints are used to calculate fixed costs and to support team composition constraints. The fifth set (50) of constraints bounds cost on each task, and the sixth constraint (51) bounds total cost. The seventh set of constraints (52) bounds risk on each task, and the eighth constraint (53) bounds total risk. The ninth set of constraints (54) is used to bound the size of each team; the tenth set (55) represents skills assignment and the eleventh set (56) represents skills availability. The twelfth set of constraints (57) is used to control team composition, and can capture considerations such as the combination of teams that a resource can be assigned to and the combination of resources that can be assigned to a team.

$$MIN {w}_{cst} ( {\sum }_{t ∈ T} {\sum }_{r ∈ R} {f}_{t , r} {x}_{t , r} + {\sum }_{t ∈ T} {\sum }_{r ∈ R} {\sum }_{i ∈ I} {f}_{t , r , i} {x}_{t , r , i} + {\sum }_{t ∈ T} {\sum }_{r ∈ R} {\sum }_{s ∈ {S}_{r}} {\sum }_{i ∈ I} {c}_{t , r , s , i} {a}_{r , i} {u}_{t , r , s , i} ) + {w}_{risk} {\sum }_{t ∈ T} {\sum }_{r ∈ R} {\sum }_{s ∈ {S}_{r}} {\sum }_{i ∈ I} {p}_{t , r , s , i} {a}_{r , i} {u}_{t , r , s , i} \qquad ( 45 )$$

Subject to:

$$\begin{matrix}{\sum }_{r ∈ R} {a}_{r , i} {e}_{r , s , i} {u}_{t , r , s , i} \geq {q}_{t , s , i} . for all s ∈ S , i ∈ I , t ∈ T & ( 46 ) \\ {\sum }_{t ∈ T} {\sum }_{s ∈ {S}_{r , i}} {u}_{t , r , s , i} \leq 1 for all r ∈ R i ∈ I & ( 47 ) \\ {\sum }_{s ∈ {S}_{r , i}} {u}_{t , r , s , i} \leq {x}_{t , r , i} for all r ∈ R , i ∈ I , t ∈ T & ( 48 )\end{matrix}$$

x_{t,r,i}≦x_{t,r} for all rεR, iεI, tεT (49)

$$\begin{matrix}\begin{matrix}{\sum }_{r ∈ R} {f}_{t , r} {x}_{t , r} + {\sum }_{r ∈ R} {\sum }_{i ∈ I} {f}_{t , r , i} {x}_{t , r , i} + \\ {\sum }_{r ∈ R} {\sum }_{s ∈ {S}_{r}} {\sum }_{i ∈ I} {c}_{t , r , s , i} {a}_{r , i} {u}_{t , r , s , i} \leq {C}_{t} for all t ∈ T\end{matrix} & ( 50 ) \\ \begin{matrix}{\sum }_{t ∈ T} {\sum }_{r ∈ R} {f}_{t , r} {x}_{t , r} + {\sum }_{t ∈ T} {\sum }_{r ∈ R} {\sum }_{i ∈ I} {f}_{t , r , i} {x}_{t , r , i} + \\ {\sum }_{t ∈ T} {\sum }_{r ∈ R} {\sum }_{s ∈ {S}_{r}} {\sum }_{i ∈ I} {c}_{t , r , s , i} {a}_{r , i} {u}_{t , r , s , i} \leq C \end{matrix} & ( 51 ) \\ {\sum }_{r ∈ R} {\sum }_{s ∈ {S}_{r}} {p}_{t , r , s , i} {a}_{r , i} {u}_{t , r , s , i} \leq {P}_{t} for all t ∈ T & ( 52 ) \\ {\sum }_{t ∈ T} {\sum }_{r ∈ R} {\sum }_{s ∈ {S}_{r}} {p}_{t , r , s , i} {a}_{r , i} {u}_{t , r , s , i} \leq P & ( 53 ) \\ {TLB}_{t} \leq {\sum }_{r ∈ R} {x}_{t , r} \leq {TUB}_{t} , for all t ∈ T & ( 54 ) \\ {SLB}_{t , s} \leq {\sum }_{r ∈ R : s ∈ Sr} {x}_{t , r} , for all s ∈ S , t ∈ T & ( 55 ) \\ {QLB}_{t , s} \leq {\sum }_{r ∈ R s ∈ Sr} {a}_{r , i} {x}_{t , r , i} , for all s ∈ S , i ∈ I , t ∈ T & ( 56 ) \\ {LB}_{{R}^{′} , {T}^{′}} \leq {\sum }_{r ∈ {R}^{′} , t ∈ {T}^{′}} {x}_{t , r} \leq U {B}_{{R}^{′} , {T}^{′}} for all {R}^{′} ⊆ R , {T}^{′} ⊆ T & ( 57 )\end{matrix}$$

x_{t,r}ε{0,1} for all rεR,tεT (58)

x_{t,r,i}ε{0, 1} for all rεR, iεI, tεT (59)

u_{t,r,s,i}≧0 for all sεS,rεR, iεI,tεT (60)

Additional modifications to reflect constraints that apply only to specific cases are possible and can be implemented by one skilled in the art.

In particular, if a resource r can be assigned to at most nᵣ tasks, then the team composition constraint set includes constraints of the form:

$${\sum }_{t ∈ T} {x}_{t , r} \leq {n}_{r} \qquad ( 61 )$$

If a resource r can be assigned to at most n_{r,i} tasks, in the i-th interval then the team composition constraint set includes constraints of the form:

$${\sum }_{t ∈ T} {x}_{t , r , i} \leq {n}_{r , i} \qquad ( 62 )$$

If each resource is allowed to use at most one skill in any interval then the variables u can be restricted to take only integer values.

There may be instances which include the possibility of not doing some task. In this case, additional decision variables zₜ are used to represent whether (=1) or not (=0) the task is to be done. In this case, the selection of which tasks to complete may be guided by priorities specifying the relative importance of tasks, or by economic factors, such as cost or profit. These factors are typically used in an objective function.

Let Vₜ be the value of completing task t, then the total value corresponding to a combination of tasks is the sum of the values of the tasks in the combination:

$${\sum }_{t ∈ T} {V}_{t} {z}_{t} .$$

Extending the formulation above as follows:

(1) Adjust the objective function to maximize the total profit, which is value minus cost; and

(2) Restrict the allocation of resources to tasks that are selected.

The objective function then becomes:

$$\begin{matrix}MAX {\sum }_{t ∈ T} {V}_{t} {z}_{t} - ( {\sum }_{t ∈ T} {\sum }_{r ∈ R} {f}_{t , r} {x}_{t , r} + {\sum }_{t ∈ T} {\sum }_{r ∈ R} {\sum }_{i ∈ I} {f}_{t , r , i} {x}_{t , r , i} + \\ {\sum }_{t ∈ T} {\sum }_{r ∈ R} {\sum }_{s ∈ {S}_{r}} {\sum }_{i ∈ I} {c}_{t , r , s , i} {a}_{r , i} {u}_{t , r , s , i} )\end{matrix} \qquad ( 63 )$$

The additional constraints, that prevent resources from being assigned to unselected tasks, take the form:

x_{r,t}≦zᵣ for all tεT,rεR (64)

zᵣε{0,1} for all rεR (65)

When selecting tasks, precedence considerations may be required, if one task is dependent on the prior completion of another task. Precedence considerations can be represented by constraints on the task selection variables. If completion of task t1 requires that task t2 also be completed, then add a constraint of the form:

zₜ₁≦zₜ₂ (66)

With the invention, a method is provided for assembling a team from a collection of potential team members. The capabilities of each potential team member are known, for example, via a skills database or individual resumes. The inventive method for assembling a team also may consider cost or availability factors, also may assemble or modify a collection of teams. Further, the invention provides a method for using byproducts of the assembly process to determine a list of skills for which availability should be increased.

The present invention can also be used to assemble minimum sized teams. It can also be used to minimize the number of tasks to which a resource is assigned. Further, the invention recognizes that it is often not possible to complete all desirable tasks, and, thus, this invention may be used to select which tasks to complete in order to maximize value of completed work.

While the invention has been described in terms of several preferred embodiments, those skilled in the art will recognize that the invention can be practiced with modification.

Further, it is noted that, Applicant's intent is to encompass equivalents of all claim elements, even if amended later during prosecution.

What is claimed is:

1. A computer implemented method for selecting team members, the method comprising:
receiving data regarding requirements for at least one task;
receiving data regarding skills of a potential team member; and
determining whether said requirements for said at least one task are at least partially satisfied by the skills of said potential team member.

2. The method of claim 1, further comprising proposing at least one team member that fulfills the requirements of said at least one task.

3. The method of claim 1, wherein said receiving data regarding requirements comprises receiving said data from a task database.

4. The method of claim 3, wherein said task database comprises a listing of skills for said at least one task.

5. The method of claim 4, wherein said listing comprises a quantity of each skill required for said at least one task.

6. The method of claim 4, wherein said listing comprises a quantity of at least one skill required for at least one interval of time duration.

7. The method of claim 4, wherein said listing of skills comprises a location for at least one skill.

8. The method of claim 3, wherein said database comprises at least one of a budget for said at least one task, a permitted risk for said at least one task, and a value for said at least one task.

9. The method of claim 1, wherein said receiving of data regarding skills of a potential team member comprises receiving requirements from a resource database.

10. The method of claim 9, wherein said resource database comprises at least one of an identifier for a potential team member, information regarding the availability of a potential team member, a list of skills for a potential team member, a cost of providing at least one skill for a potential team member, a location of a potential team member, a measure of efficiency of providing at least one skill for a potential team member, and a measure of risk of providing at least one skill for a potential team member.

11. The method of claim 1, further comprising:
receiving data regarding skills of another potential team member; and
selecting at least one of said potential team member and said another potential team member for said at least one task.

12. The method of claim 11, wherein said selecting comprises optimizing the selecting between said at least one of said potential team member and said another potential team member for said at least one task.

13. The method of claim 11, wherein said optimizing comprises optimizing one of a cost, a team size, skill redundancy, task budget, and maximization of value.

14. The method of claim 12, wherein said optimizing is based upon a cost of providing at least one skill of said at least one of said potential team member and a cost of providing at least one skill of said another potential team member.

15. The method of claim 14, wherein said cost of providing at least one skill includes a distance from a project location for each of said at least one of said potential team member and said another potential team member.

16. The method of claim 11, wherein a maximum size of said team is specified.

17. The method of claim 11, wherein a minimum number of resources with a given skill is specified.

18. The method of claim 11, wherein a maximum risk is specified.

19. The method of claim 11, where a maximum budget is specified.

20. The method of claim 11, further comprising selecting tasks to be left incomplete.

21. The method of claim 20, wherein said selecting comprises optimizing total value.

22. The method of claim 11, further comprising proposing at least two teams for said at least one task.

23. The method of claim 1, further comprising creating a task database for storing said requirements of said at least one task.

24. The method of claim 1, further comprising creating a resource database for storing said data regarding skills of said potential team member.

25. The method of claim 24, wherein said creating said resource database comprises extracting attributes from at least one resume of said potential team member.

26. The method of claim 1, further comprising inviting said potential team member to join said team if said requirements are at least partially satisfied by the skills of said potential team member.

27. The method of claim 26, further comprising receiving a response to said invitation and selecting another potential team member if said response is a rejection.

28. A computer readable medium storing instructions for selecting team members, which when executed by one or more processors, causes one or more processors to perform:
receiving data regarding requirements for at least one task;
receiving data regarding skills of a potential team member; and
determining whether said requirements are at least partially satisfied by the skills of said potential team member.

29. A team member selection apparatus comprising:
means for receiving data regarding requirements for at least one task;
means for receiving data regarding skills of a potential team member; and
means for determining whether said requirements are at least partially satisfied by the skills of said potential team member.

30. A team member selection apparatus comprising:
A first device that receives requirements for at least one task;
A second device that receives data regarding skills of a potential team member; and
A third device that determines whether said requirements are at least partially satisfied by the skills of said potential team member.
